(19) United States
(12) Patent Application Publication
(10) Pub. No.: US 2024/0278328 A1
(43) Pub. Date: Aug. 22, 2024

(54) FORWARD-FACING TWO-SPINDLE LATHE

(71) Applicant: FUJI CORPORATION, Chiryu (JP)

(72) Inventors: Osamu NAGAI, Nagoya-shi (JP); Shigefumi SUZUYAMA, Toyota-shi (JP); Jun YANAGISAKI, Toyota-shi (JP); Hideo GOTSU, Okazaki-shi (JP); Toshifumi SUZUKI, Toyota-shi (JP); Kazuya ASAKAWA, Toyota-shi (JP)

(73) Assignee: FUJI CORPORATION, Chiryu (JP)

(21) Appl. No.: 18/688,815

(22) PCT Filed: Oct. 22, 2021
(86) PCT No.: PCT/JP2021/039126

§ 371 Date: Mar. 4, 2024

(51) Int. Cl. B23B 3/16; B23B 13/04

(52) U.S. Cl. CPC B23B 3/161; B23B 13/04

(57) ABSTRACT

A forward-facing two-spindle lathe includes a first main spindle device and a second main spindle device, a first turret device and a second turret device, each including multiple tools configured to perform machining on a workpiece gripped by a main spindle chuck of one or both of the first main spindle device and the second main spindle device, an auxiliary device disposed between the first main spindle device and the second main spindle device and configured to perform a predetermined operation such as machining on a workpiece gripped by the main spindle chuck of one or both of the first main spindle device and the second main spindle device, and a control device configured to control driving of the first main spindle device, the second main spindle device, the first turret device, the second turret device, and the auxiliary device.

### TECHNICAL FIELD

The present disclosure relates to a forward-facing two-spindle lathe including an auxiliary device that performs a predetermined operation on a workpiece gripped by each main spindle chuck of a first main spindle device and a second main spindle device.

### BACKGROUND ART

There are various demands for a machine tool, and one of them is, for example, a reduction in cycle time in machining a workpiece. Patent Literature 1 below discloses a lathe including two main spindle devices and one backward-facing main spindle device. A first main spindle base and a second main spindle are placed on a bed so as to be slidable in a parallel Z-axis direction, and workpieces respectively gripped by the first main spindle and the second main spindle are guided by first and second guide bushes so as to be slidable in the Z-axis direction. The first tool base or the second tool base is provided to be located above and below a reference straight line orthogonal to center lines of the first main spindle and the second main spindle and to move in parallel to the reference straight line. Further, a backward-facing main spindle base which is movable in a direction parallel to a reference line and includes a chuck for holding a workpiece is provided, and an opposing tool base is fixed to a side surface of the backward-facing main spindle base. In a machining process, a predetermined machining is performed by moving the first main spindle base, the second main spindle base, or the backward-facing main spindle base with respect to a round rod workpiece that is chucked and rotated by the first main spindle or the second main spindle.

### PATENT LITERATURE

Patent Literature 1: JP-A-H8-112738

### BRIEF SUMMARY

### Technical Problem

According to an NC lathe of the conventional art, one backward-facing main spindle is alternately used for two forward-facing main spindles, a workpiece in which the same machining is performed by shifting the machining process by a half cycle between the first main spindle and the second main spindle is transferred to the backward-facing main spindle, and the same back surface machining is also performed on a workpiece received from any one main spindle. According to the conventional art, one kind of component can be machined with twice the machining efficiency in a case of one spindle. However, the entire machine body of an NC lathe of the conventional art in which a backward-facing main spindle device is added in addition to two main spindle devices may be made large, and a structure may also be complicated.

Accordingly, in order to solve the problem, an object of the present invention is to provide a forward-facing two-spindle lathe including an auxiliary device between a first main spindle device and a second main spindle device.

### Solution to Problem

A forward-facing two-spindle lathe according to an aspect of the present disclosure includes a first main spindle device and a second main spindle device, in which a rotation axis of a main spindle is disposed on left and right sides in a machine body front-rear direction, respectively, a first turret device and a second turret device, each including multiple tools configured to perform machining on a workpiece gripped by a main spindle chuck of one or both of the first main spindle device and the second main spindle device, an auxiliary device disposed between the first main spindle device and the second main spindle device and configured to perform a predetermined operation on a workpiece gripped by the main spindle chuck of one or both of the first main spindle device and the second main spindle device, and a control device configured to control driving of the first main spindle device, the second main spindle device, the first turret device, the second turret device, and the auxiliary device.

### Advantageous Effects

According to the configuration, workpieces are gripped by a first main spindle device and a second main spindle device disposed on the left and right sides, and predetermined machining is performed on the workpiece by a tool revolved and indexed in a first turret device and a second turret device. At this time, when an auxiliary device disposed between the first main spindle device and the second main spindle device is, for example, an auxiliary machining device including a tool, machining of a workpiece gripped by the first main spindle device or the second main spindle device can be performed simultaneously with a machining operation performed by the first turret device or the second turret device.

### BRIEF DESCRIPTION OF DRAWINGS

FIG. 1 is an external perspective view illustrating one embodiment of a forward-facing two-spindle lathe.

FIG. 2 is a perspective view illustrating an internal structure of one embodiment of the forward-facing two-spindle lathe without a machine body cover.

FIG. 3 is a perspective view illustrating a structure of a drive section of the forward-facing two-spindle lathe.

FIG. 4 is an external perspective view illustrating an auxiliary machining device from a rear side.

FIG. 5 is a block diagram illustrating a control system that controls the forward-facing two-spindle lathe.

FIG. 6 is a diagram illustrating one example of a machining process of surface machining of a workpiece.

FIG. 7 is a view illustrating simultaneous machining by a first turret device and an auxiliary machining device.

FIG. 8 is a perspective view illustrating a part of the forward-facing two-spindle lathe in which an auxiliary device is a workpiece transfer device.

FIG. 9 is a perspective view illustrating a part of the forward-facing two-spindle lathe in which an auxiliary device is used as a tailstock device.

### DESCRIPTION OF EMBODIMENTS

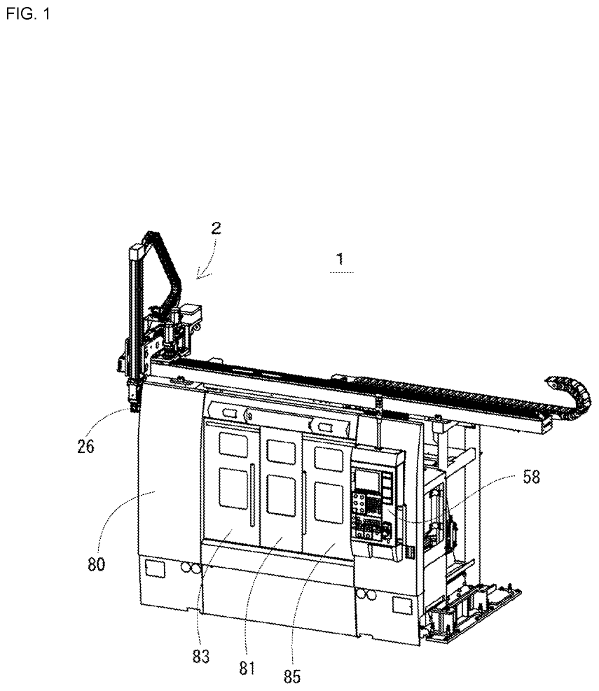

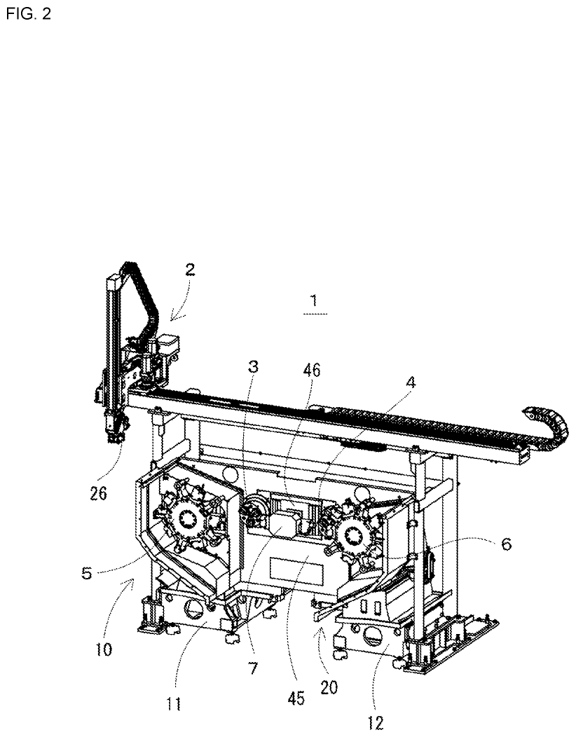

One embodiment of a forward-facing two-spindle lathe of the present disclosure will be described below with reference to the drawings. FIG. 1 is an external perspective view illustrating a forward-facing two-spindle lathe, and FIG. 2 is a perspective view illustrating an internal structure of the forward-facing two-spindle lathe without a machine body cover. Forward-facing two-spindle lathe 1 includes first main spindle device 3 and second main spindle device 4 which are respectively disposed on the left and right, and first turret device 5 and second turret device 6, and auxiliary machining device 7 is provided between first main spindle device 3 and second main spindle device 4. A machining chamber is provided in a machine covered by machine body cover 80, and slide doors 83 and 85 that can be opened and closed are provided on a front surface of machine body cover 80 on both left and right sides of central section 81 where auxiliary machining device 7 is located.

In forward-facing two-spindle lathe 1, a workpiece stocker on which multiple unmachined workpieces are mounted is disposed on the left side when viewed from the front, and a recovery stocker for receiving a machined workpiece is disposed on the right side. Forward-facing two-spindle lathe 1 is provided with workpiece automatic conveyance machine 2 for automatically conveying a workpiece between the stocker (not illustrated) and the inside of a machine. Workpiece automatic conveyance machine 2 is a gantry type workpiece conveyance machine and is attached to an upper portion of the machine body of forward-facing two-spindle lathe 1. Workpiece automatic conveyance machine 2 has a structure capable of moving robot hand 26 capable of gripping and releasing a workpiece in a traveling axis direction which is a machine body width direction, a front-rear axis direction which is a machine body front-rear direction, and an up-down axis direction which is a machine body up-down direction.

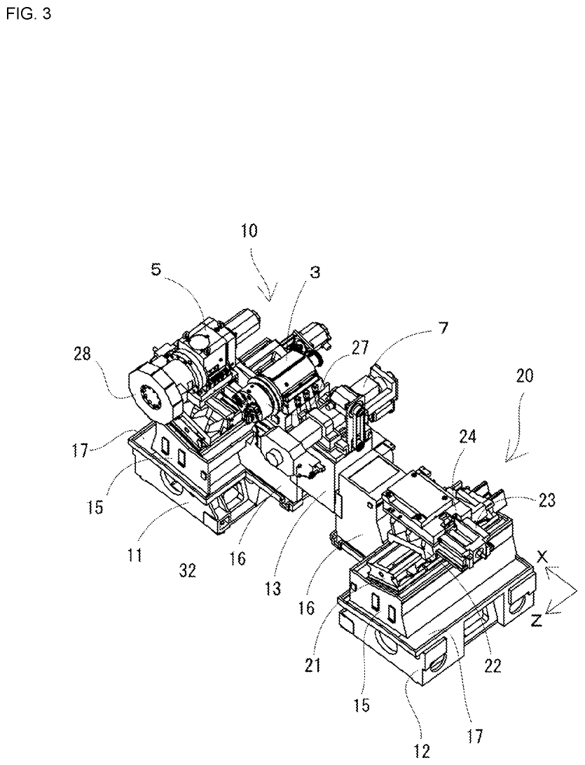

Here, FIG. 3 is a perspective view illustrating a structure of a drive section of forward-facing two-spindle lathe 1. In forward-facing two-spindle lathe 1, first main spindle device 3 and first turret device 5 are attached onto first bed 11, and second main spindle device 4 and second turret device 6 are attached onto second bed 12. However, second main spindle device 4 and second turret device 6 are omitted in the drawing. First bed 11 and second bed 12 are connected to each other through intermediate block 13, and auxiliary machining device 7 is attached onto intermediate block 13.

Forward-facing two-spindle lathe 1 of the present embodiment is obtained by adding auxiliary machining device 7, which is an auxiliary device, to a basic structure of forward-facing two-spindle lathe including first and second main spindle devices 3 and 4 disposed on the left and right and first and second turret devices 5 and 6. Since first machining section 10 of first main spindle device 3 and first turret device 5 and second machining section 20 of second main spindle device 4 and second turret device 6 have a left-right symmetrical structure, the structure will be described with a focus on first machining section 10, and the same reference numerals are given to the same configurations of second machining section 20 and descriptions thereof will be omitted.

First bed 11 and second bed 12 include turret base 15 and main spindle base 16, and main spindle base 16 is formed to protrude toward the center. Oil pan 17 is formed below turret base 15 and main spindle base 16. First main spindle device 3 is fixed on main spindle base 16, and turret device 5 attached onto turret base 15 is configured to be movable in the Z-axis direction and the X-axis direction by a drive mechanism. A movement direction of turret device 5 in the drive mechanism will be described with a machine body front-rear direction as the Z-axis direction and a machine body width direction as the X-axis direction.

An upper surface of turret base 15 is an oil pan inclined toward the center of a machine body, and Z-axis rail block 21 is mounted thereon. Z-axis slide 22 is slidably attached to Z-axis rail block 21. In Z-axis rail block 21, a screw shaft connected to a drive motor is axially supported in the Z-axis direction, and a ball screw mechanism is configured by screwing the screw shaft into a nut section formed on Z-axis slide 22. Z-axis slide 22 is integrally formed with X-axis rail block 23, and X-axis slide 24 is slidably attached thereto. In X-axis rail block 23, a screw shaft connected to a drive motor is axially supported in the X-axis direction, and a ball screw mechanism is configured by screwing the screw shaft into a nut section formed on X-axis slide 24.

Two parallel rail sections are formed in Z-axis rail block 21, and the rail sections on a center side of a machine body are attached with a low inclination. X-axis rail block 23 disposed on Z-axis rail block 21 is formed with two rail sections in the same manner, and the rail sections are attached to have the same height. Accordingly, turret device 5 attached onto X-axis slide 24 is horizontally moved in X-axis direction. There is main spindle base 16 next to a position where a drive mechanism of turret device 5 is assembled, and main spindle device 3 is fixed thereon.

Main spindle device 3 is provided with main spindle chuck 27 for gripping a workpiece on a front side and is configured to rotate the gripped workpiece by receiving rotation of a spindle motor. Turret device 5 is configured such that multiple tools are detachably attached to a polygonal tool base 28, and tool base 28 is revolved by rotation control of a servo motor of turret device 5, and a specific tool can be revolved and indexed by multiple attached tools. Accordingly, predetermined machining such as outer-diameter cutting is performed as the workpiece gripped by main spindle chuck 27 revolves and the revolved and indexed cutting tool comes into contact with the workpiece by movement of turret device 5.

Pair of main spindle devices 3 and 4 are fixed to the center side of forward-facing two-spindle lathe 1, and movable turret devices 5 and 6 are respectively disposed outside main spindle devices 3 and 4, and by securing a certain space in the center, various auxiliary devices such as auxiliary machining device 7 can be attached. In a bed structure in which first bed 11 and second bed 12 are separated from each other as in the present embodiment, intermediate block 13 can be designed to have any dimension to some extent. Therefore, intermediate block 13 having a reduced dimension on which auxiliary machining device 7 can be mounted is fixed to pair of left and right main spindle bases 16, and forward-facing two-spindle lathe 1 includes main devices respectively mounted on first and second beds 11 and 12 connected in this way.

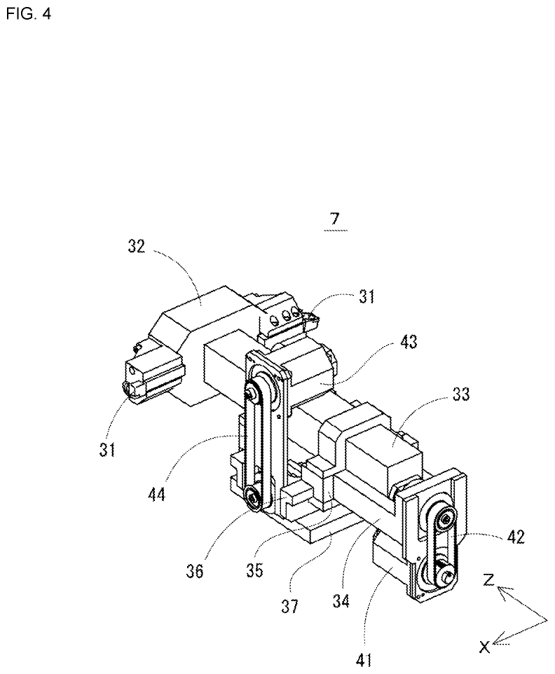

Next, FIG. 4 is an external perspective view illustrating auxiliary machining device 7 from a rear side. Auxiliary machining device 7 includes tool head 32 to which tool 31 is attached to protrude toward both left and right sides. Tool head 32 is fixed to a front end portion of Z-axis slide 33 of a prismatic shape, and Z-axis slide 33 is accommodated in Z-axis rail holder 34 and attached in a state of being slidable in the Z-axis direction. Z-axis rail holder 34 is formed integrally with X-axis slide 35, and X-axis slide 35 is attached to be slidable with respect to X-axis rail 36 fixed to base plate 37.

Z-axis slide 33 has a ball screw mechanism in which a screw shaft is screwed into a nut section formed therein, and the rotation of Z-axis motor 41 is transferred to the screw shaft through belt 42. Further, X-axis slide 35 has a ball screw mechanism in which a screw shaft axially supported in X-axis rail 36 is screwed into a nut section thereof, and the rotation of X-axis motor 43 is transferred to the screw shaft through belt 44. Auxiliary machining device 7 is fixed to intermediate block 13 by base plate 37, and tool 31 of tool head 32 can be positioned by driving of Z-axis motor 41 and X-axis motor 43.

Forward-facing two-spindle lathe 1 is provided with wall surface plate 45 constituting a machining chamber as illustrated in FIG. 2 to protect a drive mechanism of each device from a coolant, a chip, and the like scattered during machining of a workpiece. Bellows cover 46 is provided on wall surface plate 45, and auxiliary machining device 7 can be moved in the Z-axis direction in a state where Z-axis slide 33 passing through a central portion of bellows cover 46 is subjected to a sealing process.

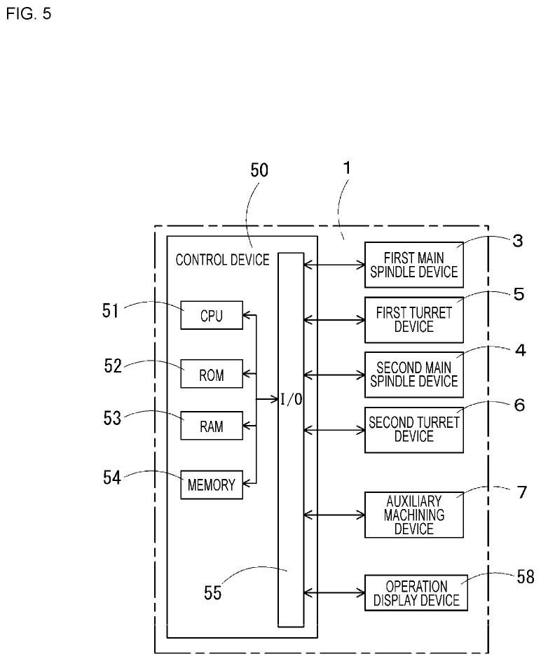

Next, FIG. 5 is a block diagram illustrating a control system for controlling forward-facing two-spindle lathe 1. Microprocessor (CPU) 51, ROM 52, RAM 53, and nonvolatile memory 54 are connected to control device 50 of forward-facing two-spindle lathe 1 through a bus line. CPU 51 performs overall control of the entire control device, and ROM 52 stores a system program to be executed by CPU 51, control parameters, and the like, and RAM 53 stores temporary computation data, display data, and the like.

Nonvolatile memory 54 stores information necessary for processing performed by CPU 51 and stores a sequence program or the like of forward-facing two-spindle lathe 1. I/O port 55 is provided in control device 50, and first and second main spindle devices 3 and 4, first and second turret devices 5 and 6, and drive motors of auxiliary machining device 7, workpiece automatic conveyance machine 2, and the like are connected to each other through I/O port 55 thereof through respective drivers. Further, as illustrated in FIG. 1, in forward-facing two-spindle lathe 1, operation display device 58 of a touch panel type is attached to a front portion of a machine body and is connected to control device 50 through I/O port 55.

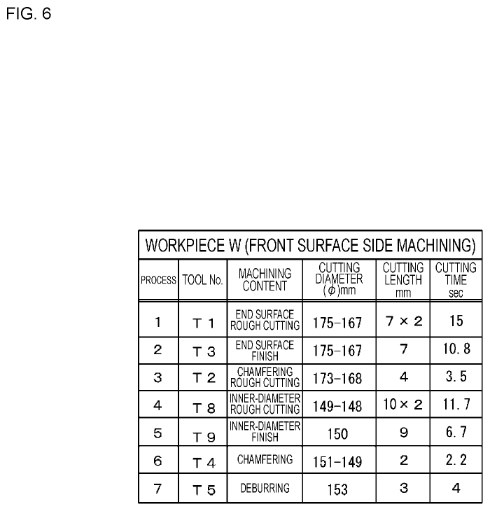

Subsequently, FIG. 6 is a diagram illustrating a machining process for surface machining of workpiece W. In the known forward-facing two-spindle lathe, when machining of both front and back surfaces of a workpiece is performed, front side machining is performed in a first machining section, and back side machining is performed in the second machining section. However, in the front and back double-sided machining, when machining contents of the front side and the back side are different from each other, machining times thereof are also different from each other. For example, in an example illustrated in FIG. 6, the machining time of the front surface, which includes positioning determination time, indexing time, and the like, requires 65 seconds, while machining of the back surface (not illustrated) ends in 58 seconds. Since there is a time difference in machining performed in two axes in this way, timing of workpiece conveyance is matched with a longer machining time, and cycle time of the entire machining is extended.

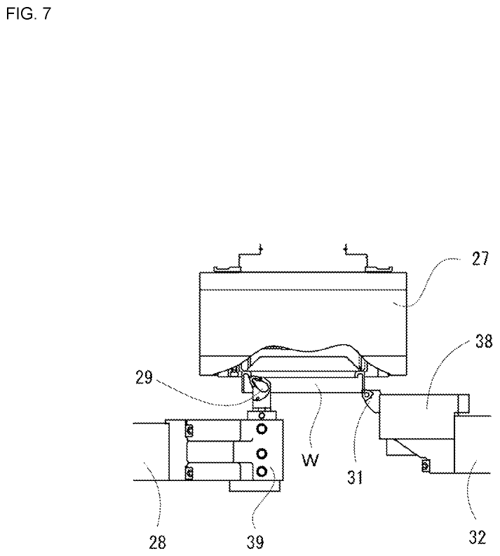

Forward-facing two-spindle lathe 1 performs machining control using auxiliary machining device 7 for the purpose of reducing a cycle time. For example, in auxiliary machining device 7, in order to share end surface rough cutting of a first process illustrated in FIG. 6 with respect to workpiece W, tool 31 that is a bite is attached to tool head 32 by outer-diameter holder 38. FIG. 7 is a view illustrating simultaneous machining by first turret device 5 and auxiliary machining device 7. In first turret device 5, tool 29 that is a bite is attached to tool base 28 through inner-diameter holder 39 and is positioned at a machining position by revolving and indexing.

Therefore, with respect to workpiece W gripped by main spindle chuck 27 of first main spindle device 3, tool 29 is moved by driving of first turret device 5, and tool 31 is moved by driving of auxiliary machining device 7. Tools 29 and 31 come into contact with predetermined portions of rotating workpiece W, inner-diameter rough cutting is performed by tool 29, and an end surface rough cutting is performed by tool 31. In the example illustrated in FIG. 6, cutting time takes 15 seconds for tool 31 to repeat end surface rough cutting of a cutting length of 7 mm twice, and during this time, inner-diameter rough cutting (cutting time of 11.7 seconds) of a cutting length of 10 mm, which is repeated twice, is performed simultaneously by tool 29 positioned according to timing.

Thus, forward-facing two-spindle lathe 1 of the present embodiment can reduce the time required for the first machining on a front surface side of a workpiece by causing auxiliary machining device 7 to share a part of entire machining performed beforehand by a tool mounted on first turret device 5. Accordingly, machining time for a front surface of a workpiece, which is normally longer than the machining time for a back surface of the workpiece that had to be performed in parallel in the past, is reduced, and a cycle time can be reduced. Further, not only machining on first machining section 10 side but also machining on second machining section 20 side which is performed in parallel, can be simultaneously performed by auxiliary machining device 7 depending on a machining process, and thus, the cycle time can be further reduced. Since the machining using auxiliary machining device 7 depends on a machining process and a machining content of a used workpiece, possibility of reducing the cycle time and a reduction time varies.

In forward-facing two-spindle lathe 1, first machining section 10 and second machining section 20 are divided into first bed 11 and second bed 12 on the left and right, and accordingly, a structure is provided that facilitates a design change, such as addition of an auxiliary device, for example, auxiliary machining device 7 to the middle thereof. Although auxiliary machining device 7 is attached onto intermediate block 13, a dimension and configuration of intermediate block 13 can be changed by an auxiliary device to be described below.

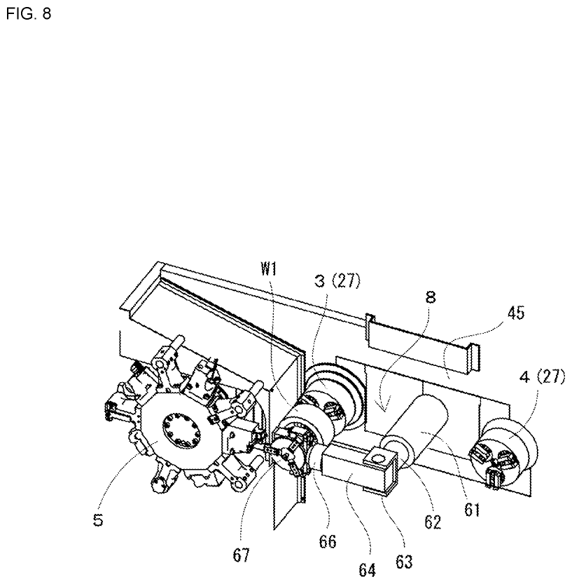

Next, FIG. 8 is a perspective view illustrating a part of forward-facing two-spindle lathe 1 using a workpiece transfer device as an auxiliary device. In workpiece transfer device 8, electric cylinder 61 is fixed to protrude from wall surface plate 45 in the Z-axis direction, and arm 64 is swingably connected to a front end portion of extension-compression rod 62 through joint section 63. Robot hand 67 is attached to a front end of arm 64 through rotation section 65. Robot hand 67 has a pair of chucks for gripping workpiece W1 on both front and back sides and can be reversed by driving of rotation section 65.

In workpiece transfer device 8, extension and contraction of extension-compression rod 62 are adjusted by driving of electric cylinder 61, and a position of robot hand 67 is distributed between first main spindle device 3 and second main spindle device 4 by driving of rotation section 63. By the driving of rotation section 63, first chuck section of robot hand 67 faces main spindle chuck 27, and second chuck section is located on an opposite side. Workpiece W1 is transferred between robot hand 67 and main spindle chuck 27 or between robot hand 67 and robot hand 26 of workpiece automatic conveyance machine 2 by driving of each section. Accordingly, in forward-facing two-spindle lathe 1 including workpiece transfer device 8, a front surface side of a workpiece is machined by first main spindle device 3 without using an external reversing device, and then workpiece W1 reversed in a machine is transferred to second main spindle device 4 by workpiece automatic conveyance machine 2, and thus, cycle time can be reduced.

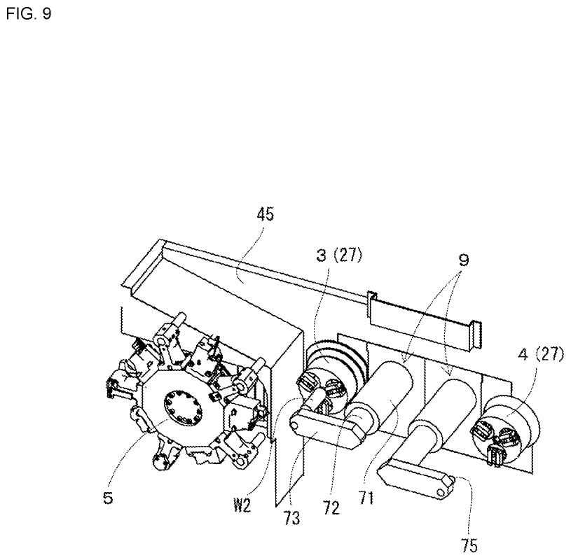

Next, FIG. 9 is a perspective view illustrating a part of forward-facing two-spindle lathe 1 using a tailstock device as an auxiliary device. Tailstock device 9 is provided for each of first main spindle device 3 and second main spindle device 4. In tailstock device 9, electric cylinder 71 is fixed to protrude from wall surface plate 45 in the Z-axis direction, and arm 73 is fixed to a front end portion of extension-compression rod 72 in a posture horizontal to an orthogonal direction. Arm 73 is provided with tailstock pin 75 for rotatably supporting a central axis of workpiece W2 at a front end portion thereof.

In tailstock device 9, extension and contraction of extension-compression rod 74 are adjusted by driving of electric cylinder 71, and tailstock pin 75 is pressed against the center of an end surface of workpiece W2 gripped by main spindle chuck 27. Thus, a posture of workpiece W2 having a long dimension in an axis direction during machining can be stabilized, and machining accuracy can be maintained. In particular, although it was difficult to install a tailstock device in a machine tool having a structure like forward-facing two-spindle lathe 1, this point can be solved.

Although one embodiment of the present disclosure is described, the present disclosure is not limited thereto, and various modifications can be made without departing from the gist thereof.

For example, auxiliary machining device 7 described as one of auxiliary devices is described as an example in which a position of tool 31 is fixed, but the auxiliary machining device that assists the machining may be configured to be able to revolve and index multiple tools, such as miniaturized first turret device 5.

### REFERENCE SIGNS LIST

1: forward-facing two-spindle lathe, 2: workpiece automatic conveyance machine, 3: first main spindle device, 4: second main spindle device, 5: first turret device, 6: second turret device, 7: auxiliary machining device, 10: first machining section, 11: first bed, 12: second bed, 13: intermediate block, 20: second machining section, 50: control device

1. A forward-facing two-spindle lathe comprising:
a first main spindle device and a second main spindle device, in which a rotation axis of a main spindle is disposed on left and right sides in a machine body front-rear direction, respectively;
a first turret device and a second turret device, each including multiple tools configured to perform machining on a workpiece gripped by a main spindle chuck of one or both of the first main spindle device and the second main spindle device;
an auxiliary device disposed between the first main spindle device and the second main spindle device and configured to perform a predetermined operation on a workpiece gripped by the main spindle chuck of one or both of the first main spindle device and the second main spindle device; and
a control device configured to control driving of the first main spindle device, the second main spindle device, the first turret device, the second turret device, and the auxiliary device.

2. The forward-facing two-spindle lathe according to claim 1, further comprising a first bed on which the first main spindle device and the first turret device are mounted, a second bed on which the second main spindle device and the second turret device are mounted, and the intermediate block which is fixed between the first bed and the second bed and on which the auxiliary device is mounted.

3. The forward-facing two-spindle lathe according to claim 1, wherein the auxiliary device is a auxiliary machining device including a tool configured to perform machining on the workpiece gripped by the main spindle chuck of one or both of the first main spindle device and the second main spindle device.

4. The forward-facing two-spindle lathe according to claim 3, wherein the control device causes the first turret device or the second turret device and the auxiliary machining device to simultaneously machine the workpiece gripped by the main spindle chuck of the first main spindle device or the second main spindle device.

5. The forward-facing two-spindle lathe according to claim 4, wherein the control device causes the auxiliary machining device to partially perform a machining process of a workpiece having a longer machining time with regard to machining the workpieces gripped by the main spindle chuck of the first main spindle device and the second main spindle device.

6. The forward-facing two-spindle lathe according to claim 1, wherein the auxiliary device is a workpiece transfer device including a robot hand configured to transfer the workpiece between the main spindle chucks of the first main spindle device and the second main spindle device.

7. The forward-facing two-spindle lathe according to claim 1, wherein the auxiliary device is a tailstock device configured to perform tailstock of the workpieces gripped by the main spindle chucks of the first main spindle device and the second main spindle device.
